(19) United States
(12) Patent Application Publication
(10) Pub. No.: US 2013/0191152 A1
(43) Pub. Date: Jul. 25, 2013

(54) METHOD AND SYSTSM FOR ACCESSING PATIENT DATA

(71) Applicants: Malika Cremer, Basel (CH); Christopher N. Anderson, Basel (CH)

(72) Inventors: Malika Cremer, Basel (CH); Christopher N. Anderson, Basel (CH)

(21) Appl. No.: 13/497,323

(22) PCT Filed: Sep. 20, 2010
(86) PCT No.: PCT/US10/49438

§ 371 Date: Mar. 21, 2012

Related U.S. Application Data
(60) Provisional application No. 61/246,706, filed on Sep. 29, 2009.
(60) Provisional application No. 61/261,470, filed on Nov. 16, 2009.

(51) Int. Cl. G06F 19/00

(52) U.S. Cl. CPC G06F 19/322
USPC 705/3

(57) ABSTRACT

Data concerning patients that have received treatment by a drug is stored and accessed to it is provided. One or more storage elements are provided that contain data concerning patients that have received the drug. The data includes data from clinical trials and data from patients prescribed the drug by a physician. A processor is programmed to search the storage elements for data on patients meeting a specified profile and to create a dataset. The dataset includes information on the patients having the specified profile, including a response of the patients to treatment using the drug.

### BACKGROUND OF THE INVENTION

Pharmaceutical compositions are widely available to treat many different physical and mental ailments. As more and more patients are treated with a given pharmaceutical composition, more and more data is collected about the pharmaceutical. Such data often includes the effectiveness of the pharmaceutical at various dosages, side-effects associated with the pharmaceutical, interactions with other drugs or substances and need for follow-up care. While data on patients is carefully tracked prior to approval of the drug for sale (for example, in clinical trials), after approval, and the drugs begins being prescribed to patients, there is less systematic collection of information on the drug and patients' reactions to it. Except in the case of severe reactions, even the data collected if often not widely disseminated.

Drugs are active compounds, and thus in addition to their action in treating or preventing a disease, they may also induce undesirable side effects or adverse reactions. It is the reason why before authorizing new drugs to be marketed, the Health Authorities require extensive studies to establish the safety profile of such drugs. More and more often the Health Authorities also require the setting of specific risk management plans to permit the physicians prescribing the drug to mitigate the risks possibly associated with administering said drugs.

### SUMMARY OF THE INVENTION

The present invention pertains to a new system and computerized method to assist and support health care professionals in charge of treating patients with a drug, e.g. a S1P receptor modulator or agonist, or a drug for treating multiple sclerosis, in order to permit said care professionals to treat the patients in the most adequate and efficient way, while limiting the side effect or adverse event possibly associated with said drug. This assistance may consist of providing the most possible available information on the drug, including but not limited to its safety profile. It may consist of providing support for setting or implementing follow up care or monitoring steps, or a risk management plan, e.g. as required by the Health Authorities. In a specific embodiment, this assistance may consist of informing the patient, e.g. remotely, about the location of adequate health care professionals who can perform the necessary follow up care or monitoring steps.

More specifically, the present invention is directed to a system for storing and providing access to data concerning patients that have received treatment by a drug. One or more storage elements are provided that contain data concerning patients or healthy volunteers that have received the drug. The data includes data from clinical trials and data from patients prescribed the drug by a physician. A processor is programmed to search the storage elements for data on patients meeting a specified profile and to create a dataset.

The dataset includes information on patients having the specified profile, including a response of patients to treatment using the drug, e.g. a S1P receptor agonist or a multiple sclerosis drug. The dataset may further include data related to the mode of action of the concerned drug, and/or on the side effects or adverse reactions possibly expected based on the mode of action of the drug. It may include data related to the identified side effects or adverse reactions experienced by persons having taken that drug, either prior recipients who participated in a clinical trial for the drug or were prescribed the drug by a prescribing physician.

The dataset may contain data on the specific disease to be treated, e.g. multiple sclerosis, in particular on the known side effects and adverse reactions that have been experienced by patients affected by that disease. The dataset may also contain data on drug on the market for said disease, e.g. known multiple sclerosis drugs, in particular on the known side effects and adverse reactions that have been experienced by patients taking that drug.

In another embodiment, the dataset may include data generated on clinical trials preformed with the drug to be administered to the patient and/or data obtained in patients who have been prescribed the drug by a physician, e.g. multiple sclerosis patients.

The present invention is further directed to a system and method of evaluating suitability of treating a patient with a drug. Data concerning the patient is entered into a computer, the data including a patient profile. Patient profile may include data on the gender, age, as well as for example disease history and/or medical history of the patient. Disease history may be description of the disease is to be treated, the stage of said disease, the symptoms and disorders associated thereof. Medical history of the patient may be include one or more of the following parameters: is the patient or not under medication, if yes is it for the same disease or not, for how long, which side effects or adverse reactions has he experienced so far, etc. . . . , e.g. is the patient taking another multiple sclerosis drug, at which dosing regimen, etc. . . . Data on medical history may also include the specific medical analysis performed for this patient, the specific points of time when such analysis have been performed and the results thereof. For example, it may include the results of blood analysis performed before staring and/or during treatment with the concerned drug; or measurement of heart rate at specific points of time.

The computer is used to compare the patient profile with data stored within the computer concerning the profiles of prior recipients of said drug. Based on said comparison, prior recipients that have profiles that are at least in part the same as the profile of the patient under evaluation for treatment with the drug are identified. Data concerning the identified prior recipients and the experiences of the identified prior recipients with the drug is provided for the purpose of evaluating the suitability of treatment of the patient with the drug.

In another embodiment of the invention, there is provided a system and method of determining the risk of adverse events possibly associated with treating a patient with a drug. Data concerning the patient, e.g. patient profile, is entered into a computer, the data including the risk profile from the possible side effects or adverse reactions of said drug. Screening examinations to determine baseline measurements for conditions which may be affected by said possible side effects or adverse effects are performed. The results obtained and the medical history of the patient are entered into a second database. A risk profile of the patient is generated. The first database is accessed and the test results in the second database are compared to the known risk profile in the first database. Measure identity of the possible risk profile and the patient risk profile is determined. A report of whether the risk of adverse event occurring of treatment with said drug is acceptable is generated.

The present invention is further directed to a system and method of implementing a follow up care and monitoring to be performed before and/or during administering a drug to a patient, for example as required by the Health Authorities. Data concerning the patient is entered into a computer, the data including a patient profile. Furthermore data concerning the follow up care or monitoring steps to be performed based on a patient profile, is entered into a computer, said data including description and timing of the follow up care or monitoring steps, and optionally location of adequate heath care professionals who can perform such follow up care or monitoring steps. The computer is used to compare the patient profile with data stored within the computer concerning the profiles of prior recipients of said drug. Based on said comparison, prior recipients that have profiles that are at least in part the same as the profile of the patient under evaluation for treatment with the drug are identified. Based on said comparison, prior recipients having received the drug that are at least in part the same as the profile of the patient under evaluation for treatment with the drug are identified. Based on said identification the follow up care or monitoring steps that have been performed to the patient and timing thereof are identified, e.g. the adequate heath care professionals who can perform such follow up care or monitoring steps are identified. Optionally, the system and method comprises providing, e.g. remotely, the patient with information related to the monitoring steps to be performed, the adequate time to have them performed, the location of adequate health care professionals who can perform the necessary follow up care or monitoring steps.

The present invention also pertains to a system and method of determining the appropriate conditions of administering a drug to a patient. Data concerning the patient is entered into a computer, the data including patient profile. Medical data concerning the patients is entered into a computer, the data including treatment dosage, dosing regimen, side effects or adverse event occurring in said patient. The computer is used to compare the patient profile with data stored within the computer concerning the profiles of prior recipients of said drug. Based on said comparison, prior recipients that have profiles that are at least in part the same as the profile of the patient under evaluation for treatment with the drug are identified. Data concerning the identified prior recipients and the experiences of the identified prior recipients with the drug is provided for the purpose of defining the most adequate conditions of treatment, e.g. dose or dosing regimen.

The present invention also pertains to a system and method of determining the appropriate follow up care and monitoring steps to be performed before or during administering a drug to a patient, for example as required by the Health Authorities. Data concerning the patient is entered into a computer, the data including patient profile. Medical data concerning the patients is entered into a computer, the data including treatment dosage, dosing regimen, side effects or adverse event occurring in said patient, and optionally the follow up care and monitoring steps performed before and during administering the drug to said patient. The computer is used to compare the patient profile with data stored within the computer concerning the profiles of prior recipients of said drug. Based on said comparison, prior recipients that have profiles that are at least in part the same as the profile of the patient under evaluation for treatment with the drug are identified. Data concerning the identified prior recipients and the follow up care and monitoring of the identified prior recipients with the drug is provided for the purpose of determining the most adequate follow up care or follow up monitoring steps to be performed before or during administering said drug to said patient.

The present invention is further directed to providing alerts to patients receiving the drug and/or health care person in charge of the patient being treated, e.g. physicians prescribing the drug, nurse in charge of said patents. The alerts can be communicated remotely. The alerts can be for example new warnings concerning the drug, new advice concerning utilization, e.g. dosing regimen or dosage. The alerts can be new warnings concerning newly identified side effect(s) or adverse event(s) associated with administering the drug. For example the alerts can be the providing of information on the nature and timing of the medical analysis and follow-up care and monitoring to be performed before or during administering the drug, on the doctor specialists who may be the most appropriate and/or more available to perform such follow-up medical analysis.

In a specific embodiment of the Invention, the present invention, relates to an information system or a computerized method of remotely providing the patient with information about the necessary follow up care or monitoring steps to be performed, and/or remotely reminding or alerting the patient about the need and adequate timing of performing the necessary follow up care or monitoring steps, and/or remotely providing the patient with information about the location of adequate health care professionals who can perform the necessary follow up care or monitoring steps.

### BRIEF DESCRIPTION OF THE DRAWINGS

FIG. 1 illustrates a block diagram of an information system according to the present invention.

FIG. 2 illustrates the process for creating or editing patients records in the drug registry.

FIG. 3 illustrates the process for issuing queries to the database holding the data comprising the drug registry.

FIG. 4 illustrates the process of issuing alerts relative to patients within the registry.

### DETAILED DESCRIPTION

[The system and method described herein allow for collecting information concerning drugs before and after regulatory approval. Such information includes how patients of different profiles (e.g., age, sex, health status) react to different dosing levels, any side effects or adverse reactions encountered, and needs for follow-up care that may emerge. This information can be provided to prescribing physicians or nurses to allow for more safe and effective use of the drugs. Moreover, mechanisms are provided to ensure that label changes, health warnings, and the like, are quickly and accurately disseminated to physicians treating patients. In addition, patients have become more sophisticated consumers of medical services and drugs. Thus, they may be provided access to and may productively use this information with regard to drugs being used by those patients.

[Thus, in accordance with systems and methods described herein, data regarding a drug and patients' experiences with the drug are assembled into databases to form a drug registry for use by doctors, nurses and, optionally, by patients being treated by the drug. In one embodiment this data includes both clinical trial data as well as data concerning post-approval uses by patients prescribed the drug by physicians. For example, the data includes information concerning a patient's medical profile as well as his or her experiences with the drug. The data may be supplied by physicians prescribing the drug, researchers researching it, and other medical professionals that have the ability to supply useful information about the drug and patient's reactions to the drug. Physicians can use this data to determine the best administering strategy for specific patients (e.g., most effective dose or dosing regimen for patients of certain profile). The physician can also use this data to evaluate the risk/benefit profile for using the drug with a particular patient, and/or refine the dosing and/or dosing regimen in view of the risk/benefit profile for a particular patient.

The described information can be selectively made available to patients to educate then about the drug, its side effects or adverse reactions, dosing information, drug interactions, and need for follow-up care or monitoring. In order to facilitate providing data to the physicians and patients, the system described herein employs a user-friendly interface, such as a web-based platform. In addition to providing data to the consumer, the information system may provide reminders and the like to patients to maximize patient compliance with the dosing regimen as well as encourage and/or facilitate appropriate follow-up care. The information system may also provide identification on other health-care providers (e.g., dermatologists, ophthalmologists) that the patient may need to contact, e.g. in the context of follow up care or monitoring. Information on these providers can be based on patient request, or, recommended based on the comparison of the patient's profile and/or drug regimen with data within the database reflective of prior patient experiences, drug labeling, or manufacturer's recommendations.

While most preferably the data regarding the drug will be available to prescribing physicians, it may also be made available to and used by other medical professionals treating the patient, such as nurses or doctors treating the patient for other conditions or treating/evaluating the patient in some medical capacity.

The information system may provide information and interacts with users in English as well as other languages so a user can use the local language in providing and obtaining information from the information system. Because it is contemplated that physicians and users may be in various countries, the data presented by the information system will comply with the labeling requirements and may other regulatory requirements of the law applicable in the user's country.

The system also provides software features to protect personal information of users, including patient personal information. The level of protection may vary from patient and user to user to comply with regulatory and legal requirements that may exist concerning patient and medical data privacy in their user's country of residence or other relevant jurisdiction.

The information system may provide a common data warehouse for all the data so that searching among both clinical trials and post-clinical trial data is facilitated. Browsing and searching tools are provided to provide convenient and efficient access to the data

The information systems and the computerized methods of the present invention can be used in connection with S1P receptors modulators or agonists, and/or multiple sclerosis drugs.

S1P receptor modulators or agonists are compounds which signal as agonists at one or more sphingosine-1 phosphate receptors, e.g. S1P1 to S1P8. Agonist binding to a S1P receptor may result, for example, in dissociation of intracellular heterotrimeric G-proteins into Gα-GTP and Gβγ-GTP, and/or increased phosphorylation of the agonist-occupied receptor and activation of downstream signaling pathways/kinases.

S1P receptor modulators or agonists are valuable compounds for the manufacture of medication for the treatment of various conditions in mammals, especially in humans.

Preferred S1P receptor modulators or agonists are, for example, compounds that in addition to their S1P binding properties also have accelerating lymphocyte homing properties, e.g. compounds that elicit a lymphopenia resulting from a re-distribution, preferably reversible, of lymphocytes from circulation to secondary lymphatic tissue, without evoking a generalized immunosuppression. Naïve cells are sequestered; CD4 and CD8 T-cells and B-cells from the blood are stimulated to migrate into lymph nodes (LN) and Peyer's patches (PP).

S1P receptor modulators or agonists are typically sphingosine phosphate analogues, such as 2-substituted 2-amino-propane-1,3 diol or 2-amino-propanol derivatives, e.g. a compound comprising a group of the formula

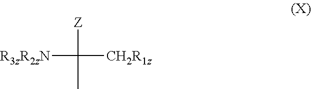

wherein Z is H, C₁₋₆ alkyl, C₂₋₆alkenyl; C₂₋₆alkynyl, phenyl, phenyl substituted by OH, C₁₋₆ alkyl substituted by 1 to 3 substituents selected from the group consisting of halogen, C₃₋₈ cycloalkyl, phenyl and phenyl substituted by OH, or CH₂—R_{4z} wherein R_{4z} is OH, acyloxy or a residue of formula (a)

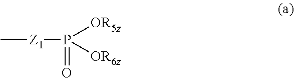

wherein Z₁ is direct bound or O, preferably O;
each of R_{5z} and R_{6z} independently, is H, or C₁₋₄ alkyl optionally substituted by 1, 2 or 3 halogen atoms;
R_{1z} is OH, acyloxy or a residue of formula (a); and each of R_{2z} and R_{3z} independently, is H, or C₁₋₄ alkyl or acyl.

Group of formula X is a functional group attached as a terminal group o a moiety which may be hydrophilic or lipophilic and comprise one or more aliphatic, alicyclic, aromatic and/or heterocyclic residues, to the extent that the resulting molecule, wherein at least one of Z and R_{1z} is or comprises a residue of formula (a), signals as an agonist at one or more sphingosine-1-phosphate receptor.

Examples of appropriate S1P receptors agonists or modulators are, for example:
Compounds as disclosed in EP627406A1, e.g. a compound of formula I

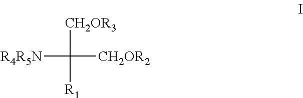

wherein R₁ is a straight- or branched (C₁₂₋₂₂) chain
which may have in the chain a bond or a hetero atom selected from a double bond, a triple bond, O, S, NR₆, wherein R₆ is H, aryl-C₁₋₄alkyl, acyl or (C₁₋₄alkoxy)carbonyl, and carbonyl, and/or
   which may have as a substituent C₁₋₄alkoxy, C₂₋₄alkenyloxy, C₂₋₄alkynyloxy, acyl, C₁₋₄alkylamino, C₁₋₄alkylthio, acylamino, (C₁₋₄alkoxy)carbonyl, (C₁₋₄alkoxy)-carbonylamino, acyloxy, (C₁₋₄alkyl)carbamoyl, nitro, halogen, amino, hydroxyimino, hydroxy or carboxy; or

### R₁ is

a phenylalkyl wherein alkyl is a straight- or branched (C₆₋₂₀)carbon chain; or—a phenylalkyl wherein alkyl is a straight- or branched (C₁₋₃₀)carbon chain wherein said phenylalkyl is substituted by
a straight- or branched (C₆₋₂₀)carbon chain optionally substituted by halogen,
a straight- or branched (C₆₋₂₀)alkoxy chain optionally substituted by halogen,
a straight- or branched (C₆₋₂₀)alkenyloxy,
phenyl-C₁₋₁₄alkoxy, halophenyl-C₁₋₄alkoxy, phenyl-C₁₋₁₄alkoxy-C₁₋₁₄alkyl, phenoxy-C₁₋₄alkoxy or phenoxy-C₁₋₄alkyl,
cycloalkylalkyl substituted by C₆₋₂₀alkyl,
heteroarylalkyl substituted by C₆₋₂₀alkyl,
heterocyclic C₆₋₂₀alkyl or
heterocyclic alkyl substituted by C₂₋₂₀alkyl,
   and wherein the alkyl moiety may have
in the carbon chain, a bond or a heteroatom selected from a double bond, a triple bond, O, S, sulfinyl, sulfonyl, or NR₆, wherein R₆ is as defined above, and
as a substituent C₁₋₄alkoxy, C₂₋₄alkenyloxy, C₂₋₄alkynyloxy, arylC₁₋₄alkyloxy, acyl, C₁₋₄alkyl-amino, C₁₋₄alkylthio, acylamino, (C₁₋₄alkoxy)carbonyl, (C₁₋₄alkoxy)carbonylamino, acyloxy, (C₁₋₄alkyl)carbamoyl, nitro, halogen, amino, hydroxy or carboxy, and
   each of R₂, R₃, R₄ and R₅, independently, is H, C₁₋₄alkyl or acyl
   or a pharmaceutically acceptable salt or hydrate thereof;
Compounds as disclosed in WO02/18395, e.g. a compound of formula IIa or IIb

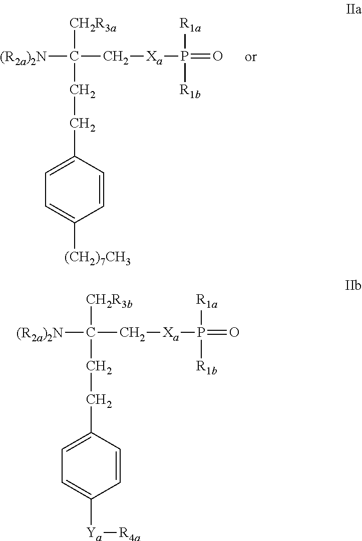

wherein Xₐ is O, S, NR₁ₛ or a group —(CH₂)ₙₐ—, which group is unsubstituted or substituted by 1 to 4 halogen; nₐ is 1 or 2, R₁ₛ is H or (C₁₋₄)alkyl, which alkyl is unsubstituted or substituted by halogen; R₁₈ is H, OH, (C₁₋₄)alkyl or O(C₁₋₄)alkyl wherein alkyl is unsubstituted or substituted by 1 to 3 halogen; R_{1b} is H, OH or (C₁₋₄)alkyl, wherein alkyl is unsubstituted or substituted by halogen; each R₃ₐ is independently selected from H or (C₁₋₄)alkyl, which alkyl is unsubstituted or substitued by halogen; R₃, is H, OH, halogen or O(C₁₋₄)alkyl wherein alkyl is unsubstituted or substituted by halogen; and R_{3b} is H, OH, halogen, (C₁₋₄)alkyl wherein alkyl is unsubstituted or substituted by hydroxy, or O(C₁₋₄)alkyl wherein alkyl is unsubstituted or substituted by halogen; Yₐ is —CH₂—, —C(O)—, —CH(OH)—, —C(═NOH)—, O or S, and R₄ₐ is (C₄₋₁₄)alkyl or (C₄₋₁₄)alkenyl;
or a pharmaceutically acceptable salt or hydrate thereof.

According to a further embodiment of the invention, a S1P receptor agonist or modulator for use in a combination of the invention may also be a selective S1P receptor, for example, a compound which possesses a selectivity for the S1P1 receptor over the S1P3 receptor of at least 20 fold, e.g. 100, 500, 1000 or 2000 fold, as measured by the ratio of EC₅₀ for the S1P1 receptor to the EC₅₀ for the S1P3 receptor as evaluated by the ³⁵S-GTPγS binding assay.

When the compounds of formula I or II have one or more asymetric centers in the molecule, the present invention is to be understood as embracing the various optical isomers, as well as racemates, diastereisomers and mixtures thereof.

The compounds of formula I or II may exist in free or salt form. Examples of pharmaceutically acceptable salts of the compounds of formula I or II include salts with inorganic acids, such as hydrochloride, hydrobromide and sulfate, salts with organic acids, such as acetate, fumarate, maleate, benzoate, citrate, malate, methanesulfonate and benzenesulfonate salts, or when appropriate, salts with metals such as sodium, potassium, calcium and aluminium, salts with amines such as triethylamine and salts with dibasic amino acids, such as lysine. The compounds and salts of the present invention encompass hydrate ad solvate forms.

In a preferred embodiment, acyl as indicated above may be a residue Ry-CO— where Ry is C₁₋₆alkyl, C₃₋₆cycloalkyl, phenyl or phenyl-C₁₋₄alkyl. Unless otherwise stated, alkyl, alkoxy, alkenyl or alkynyl may be straight or branched. Moreover, aryl may be phenyl or naphthyl, preferably phenyl.

When in the compounds of formula I the carbon chain as R₁ is substituted, it may be substituted by halogen, nitro, amino, hydroxy or carboxy. When the carbon chain is interrupted by an optionally substituted phenylene, the carbon chain may be unsubstituted. When the phenylene moiety is substituted, it may be substituted by halogen, nitro, amino, methoxy, hydroxy or carboxy.

Preferred compounds of formula I are those wherein R₁ is C₁₃₋₂₀alkyl optionally substituted by halogen, nitro, amino, hydroxy or carboxy, for example those wherein R₁ is phenylalkyl substituted by C₆₋₁₄alkyl chain optionally substituted by halogen and the alkyl moiety is a C₁₋₆alkyl optionally substituted by hydroxy. In one embodiment, R₁ is phenyl-C₁₋₆alkyl substituted on the phenyl by a straight or branched, preferably, straight, C₁₋₆alkyl chain. The C₆₋₁₄alkyl alkyl chain may be in ortho, meta or para, preferably in para.

Preferably each of R₂ to R₅ is H.

In the above formula “heterocyclic group” represents a 5- to 7 membered heterocyclic group having 1 to 3 heteroatoms selected from S, O and N. Examples of such heterocyclic groups include the heteroaryl groups indicated above, and heterocyclic compounds corresponding to partially or completely hydrogenated heteroaryl groups, e.g. furyl, thienyl, pyrrolyl, azepinyl, pyrazolyl, imidazolyl, oxazolyl, isoxazolyl, thiazolyl, isothiazolyl, 1,2,3-oxadiazolyl, triazolyl, tetrazoyl, thiadiazolyl, pyranyl, pyridyl, pyridazinyl, pyrimidinyl, pyrazinyl, tetrahydropyranyl, morpholinyl, thiomorpholinyl, pyrrolidinyl, pyrrolyl, imidazolidinyl, pyrazolidinyl, piperidinyl, piperazinyl, oxazolidinyl, isoxazolidinyl, thiazolidinyl or pyrazolidinyl. Preferred heterocyclic group is a morpholinyl, thiomorpholinyl or piperidinyl group.

A preferred compound of formula I is 2-amino-2-tetradecyl-1,3-propanediol. A particularly preferred S1P receptor agonist of formula I is FTY720, i.e. 2-amino-2-[2-(4-octylphenyl)ethyl]propane-1,3-diol (referred to hereinafter as Compound A) either in free form, in a pharmaceutically acceptable salt form, e.g. the hydrochloride, or in the form of a phosphate derivative, as shown:

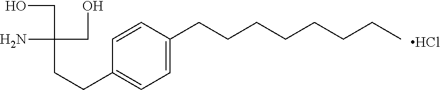 [SMILES: CCCCCCCCc1ccc(CCC(N)(CO)CO)cc1 ; Cl]

A preferred compound of formula IIa is the FTY720-phosphate (R₂ₐ is H, R₃ₐ is OH, Xₐ is O, R₁ₐ and R_{1b} are OH). A preferred compound of formula IIb is the Compound C-phosphate (R₂ₐ is H, R_{3b} is OH, Xₐ is O, R₁ₐ and R_{1b} are OH, Yₐ is O and R₄ₐ is heptyl). FTY720-phosphate is an example of phosphate derivative.

In an exemplary embodiment, the present invention concerns the field of neuroscience, inflammatory and autoimmune diseases and disorders. More particularly, the present invention relates to treatment of multiple sclerosis (MS), for example relapsing remitting multiple sclerosis (RRMS) or primary progressive multiple sclerosis (PPMS), e.g. RRMS.

Multiple sclerosis is the chief cause of neurological disability in young adults, and the most common demyelinating disorder of the central nervous system. Available therapies such as interferon-β and glatiramer acetate have modest efficacy and marginal effects on the progression of disability. These biological agents are administered parenterally and are associated, for example, with injection site reactions and pyretic symptoms. Therefore, there is a strong medical need for an effective oral treatment of multiple sclerosis.

In a specific embodiment, the invention concerns drugs to treat multiple sclerosis, in particular relapsing forms of MS.

For example the present invention can be used with patients taken beta-interferon-1a (e.g. Avonex, Rebif), beta-interferon-1b (e.g. Betaseron), glatiramer acetate (Copaxone), Natalizumab (Tysabri), cladribine, or Mitoxantrone (Novantrone).

In a specific embodiment, the invention relates to MS patients taking a S1P receptor agonist, e.g. FTY720 in free form, in a pharmaceutically acceptable salt form, or in the form of a phosphate derivative, e.g. FTY720 hydrochloride.

Of those people with multiple sclerosis who receive treatment, a significant number continue to experience disease activity clinically and experience side effects that include flu-like symptoms, immediate post-injection reactions and injection site reactions. As a result, a substantial population of patients are untreated, including many with active disease. These MS patients have either tried an existing therapy but discontinued due to intolerance, adverse effects, or perceived lack of efficacy, or have not started any therapy because of their concern with adverse effects, fear of self-injection, fear of needles, or belief that currently available options are not effective enough to warrant trial. Therefore, there is a significant unmet need for effective new therapies in MS, which limit or reduce the possible adverse events or side effects.

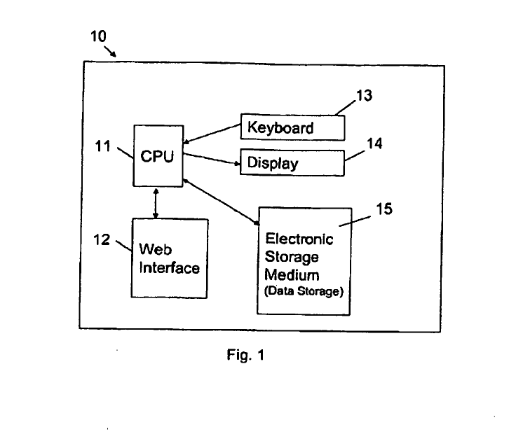

The present invention provides a computer system, preferably a web-based platform, to collect data concerning patients outcomes and side effects or adverse reactions associated with treatment with a given drug, and further provides for sharing that information in a useful way with physicians and/or patients in the future. FIG. 1 shows an exemplary system of the present invention. Computer system 10 includes a CPU 11, a web interface 12, input element (e.g. keyboard) 23, display element (e.g. LCD display) 14, and an electronic storage medium 15 that stores data concerning patients that have received a given treatment. In one embodiment, the treatment is administration of a S1P receptor modulator or agonist. In another embodiment the treatment is administration of another multiple sclerosis drug, for example beta-interferon-1a or -1b, glatiramer acetate, Natalizumab cladribine, or Mitoxantrone. In yet another embodiment the disease under treatment is multiple sclerosis. At least certain of the steps of the process described herein may be carried out by way of a computer readable medium having stored thereon instructions which, when executed by a processor, cause the processor to perform such steps.

The registry may include data from both patients who received the drug treatment during clinical trials as well as data concerning patients who received a prescription for the drug treatment according to label from a prescribing physician after drug approval. The registry may also include data from healthy volunteers who received the drug treatment during clinical trials. The data may be in a single database or multiple databases and resident on multiple storage devices in multiple locations. The CPU has access to all the data for the purpose of updating it, as well as for searching the database(s) for relevant data as discussed herein. For example the data will cover a multi-year period, e.g. five years, e.g. three years, and include data from a large variety of patients. The data registry, may, in some embodiments, be multi-national in scope. In this manner, a substantial amount of data concerning a wide variety of patients may be collected and then used for evaluation of the drug (and associated treatment regimens) by future prescribing physician.

In an exemplary embodiment, patients receiving treatment for multiple sclerosis, for example relapse forms thereof, who meet approved indication guidelines and who complete an informed consent, may be included in the registry. The treatments contemplated according to this invention include, but are not limited to, treatments using S1P receptors or agonists, including FTY720, a salt or phosphate derivative thereof, that is administered orally. The systems and methods described herein relate to the treatment of autoimmune or inflammatory diseases, e.g. multiple sclerosis, including the shortcomings mentioned above present in current MS treatments.

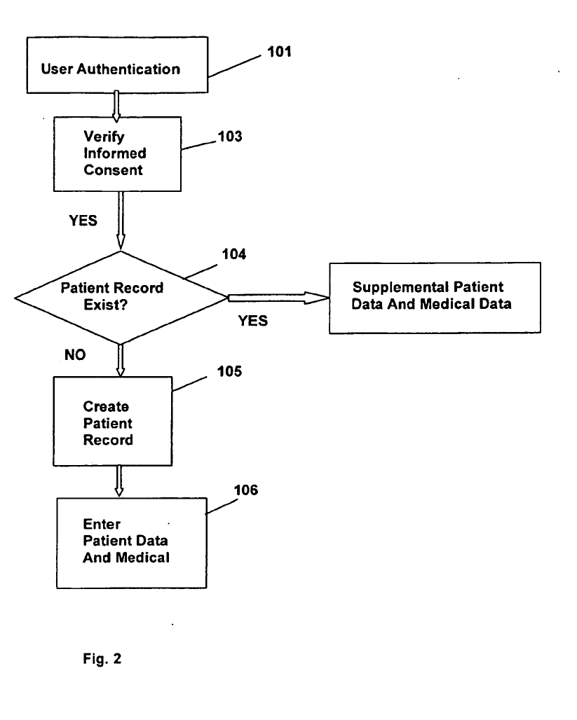

The data within the registry will be described with reference to FIG. 2. The data within the registry may include a baseline assessment of the patient's characteristics and medical condition, as would typically be collected by a physician in routine medical care. The data may include the patient's medical history as well as any co-morbidities noted in connection with the condition being treated. Socio-demographic characteristics (e.g. gender, date of birth, occupation) can be recorded and included in the registry. Vital signs (such as blood pressure and heart rate) may also be entered in the registry. Of course specific characteristics or manifestations of the disease being treated may be recorded as noted. Similarly, hematology, blood chemistry, and the results of the relevant tests that would be helpful to understanding a specific patient's reactions or responses to treatment may be included. Information on patient weight (e.g. obesity), mobility, or other observations noted by medical professional may be entered. Other test results, e.g. a pregnancy test (in women of childbearing potential) may be included to the extent they may be relevant to understanding the patient' reaction to treatment and/or assessing the treatment for future patients. Pregnancy tests may be tests performed when starting administration of the drug, and/or regular tests, e.g. on renewal of prescription. The actual data included will vary as understood in the art based on identification of relevant factors for the drug involved.

FIG. 2 illustrates an exemplary process by which this data is entered. In block 101, the physician authenticates with a user name and password. After authentication, the physician enters the informed consent form (or verifies that one is on file) in block 103. The physician enters the patient into the registry and creates a new record for the patient in the registry in blocks 104-105. The physician then enters the initial data on the patient as discussed above and illustrated in block 106. Additionally, the data entered may include dosing and dosing regimen information.

As the patients received follow-up care and assessment, additional data collected during the follow-up may be recorded in the registry. In particular, treatment outcomes or progress, and/or serious adverse events can be collected during future medical visits and entered into the registry. These future evaluations need not be conducted by the same physician in order to be entered in the registry. For example, the results of eye examinations, skin examinations, and the like, perhaps conducted by specialists in those medical fields rather than the prescribing physician, can be highly relevant to evaluating a patient's response to treatment. The data from those evaluations can be entered into the registry and associated with the patient. The same is true for follow-up tests, such as hematology and blood chemistry parameters, which may be helpful to discerning any impact of the treatment on such parameters. Turning back to FIG. 2, after authentication, it is determined that a patient record exists in the database (block 104), and the new data is associated with that patient record.

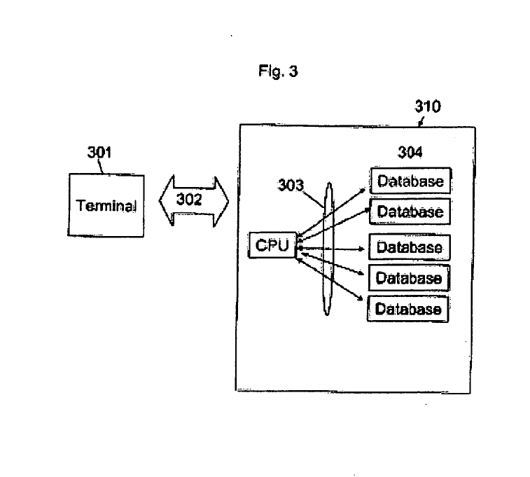

Physicians considering prescribing the drug (or other treatment) for which a registry exists may access the registry to assist in determining the suitability of the treatment for a proposed patient, and/or in determining the adequate follow-up care and/or monitoring to be performed for a proposed patient. FIG. 3 illustrates an exemplary process. Using a terminal 301, and in a preferred embodiment, a web connection 302, the physician issues queries 303 to the databases 304 in the web-based platform 310 concerning the drug in question and other criteria corresponding to the patient whose treatment is at issue. In particular, the physician may use the registry by sending queries seeking the reactions/progress of patients having similar profiles to the patient under consideration for the treatment. In one example, the physician may use the registry by sending queries seeking the follow up care and monitoring which are performed for patient treated with the same drug and optionally having the same profile than the patient under consideration for the treatment. As a more detailed example, the physician could ask to receive side effects and/or treatment outcomes for women receiving the treatment while pregnant. The web-based platform 310 searches the databases of clinical trial data and post-approval data to isolate data on pregnant women who received the drug, and provide information on treatment outcomes and any side effects or adverse effects in that patient set. The physician may also use registry to assist in determining the best dosing regimen or treatment protocol for the proposed patients. Using the above example, the historical data can be used by the physician to see which dosing regimen yielded the best results with the lowest chance of adverse effects in pregnant women.

Another feature of the computer system may be to notify medical practitioner of any risks, adverse effects, or label changes for the drug used in the treatment of a patient in the registry. Label changes, government warnings, etc. . . . can be provided to all physicians who have patients on the specified treatment in the registry. Moreover, due to the information contained in the registry, the system provides added flexibility. Information can be specifically directed to physicians and/or patients for whom information is highly relevant. For example, if the manufacturer determines that the medicine is no longer recommended for persons more than 70 of age, the system can search for patents over 70 years of age in the registry and notify the physicians treating those patients of that change. The system can notify the physician by email, instant message or an alert when the physician accesses the system. This alert can also be sent to patients directly to advise them to contact their physicians for further guidance.

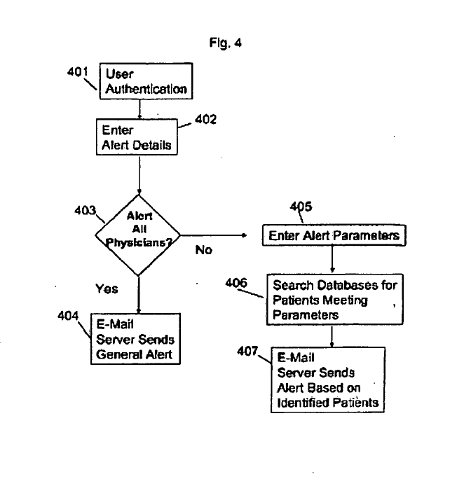

FIG. 4 illustrates a possible embodiment of the alert process, which can be performed using the elements shown in FIG. 1. In blocks 401-402, an authorized user chooses to issue an alert. In block 403, a decision is made as to whether the alert should be sent to all physicians having patients in the registry or to some subset of these physicians. In block 404, assuming the alert is intended for all physicians, an email server sends mails to all such physicians. If a more limited distribution is selected, the user sets the criteria for alerts (e.g. age of patients affected) in block 405. The information system then searches the database(s) to find records of patients on the drug that meet the search criteria in block 406. The email address (or other contact information) of physicians treating patients whose records meet the search criteria are retrieved from the records of selected patients, and an mail server forwards the alert to the relevant physicians in block 407.

The system can also report to prescribing physicians any side affects or adverse reactions that occur. The system can be flexibly designed so that serious side effects are reported to all physicians prescribing the drug, even through they may have only occurred in a small number of patients, while more minor side effects may e noted only if widespread. These determinations may be made by administrator of the registry, or alternatively, set by the physician. For example, a physician specialized in a given disease may be interested in learning of all adverse affects associated with a medication, whether numerous or not, while a general practitioner may only request to be notified of serious adverse affects. The system is flexible enough to handle both administrator-initiated notifications and doctor-initiated notifications. Users may delegate their notification to another site user. For example, a physician could delegate his alerts to another physician or nurse to monitor the alerts while the physician is on vacation or otherwise unavailable. Alerts optionally can also be provided to patients receiving the treatment. Of course, the system provides those alerts only to patients who have requested the alerts and provides an email address or other means of contact.

Because the system has information on patients and their treatments, standard protocol for follow-up treatment can be monitored and reminders issued as appropriate. For example, consider the situation where a visit to an ophthalmologist is recommended after six months of treatment. Since the date of initial treatment is in the registry, and the six-month ophthalmologist visit is programmed in the registry, the information system can monitor the patients records and issue reminders to physicians/patients at, for example, the 5 month point, that they should schedule an appoint with an ophthalmologist. The system can recommended an ophthalmologist having experience with patients using the drug if

In addition to prescribing physicians, the system and methods described herein may be used to assist with and collect data on clinical trials. For example, the computer system may maintain a repository of pertinent trial related documents. It may include videos, documents and standard forms to be used in the trials, for start-up and/or conduct of the trial. As further example, these documents may include report forms, clinical study protocols and protocol amendments, protocol packages, Investigator brochures, informed consent forms, Good Clinical Practice/Severe Adverse Effect information, training documents and regulatory forms and documents. The computer system may also provide a mechanism for physicians and/or patients to contact the investigator for a certain trial to request inclusion of his patient or himself. The system may also allow surveys to be conducted of an investigator or other trial personnel.

One advantage of the computer system and information technology platform described herein is the ability to have, in one embodiment, data concerning trials in conjunction with data concerning use by prescribing physicians. Making data available regarding both these environments in a user-friendly manner provides future prescribing physicians vast amounts of information concerning a widely-varied patient population to use in evaluating the risk/benefit analysis for treatment of a given patient, dosing or other treatment regimes that should be considered, as well as side-effects or other medical follow-up that may be required. The information technology platform may also provide a mechanism to facilitate communication with the investigator or trial site personnel, providing a prescribing physician with the ability to discuss any concerns/questions that he/she has with the treatment with persons involved in trials related to the treatment. The manufacturer may also communicate with the investigator or trial site personnel as needed through the system. The process shown in FIG. 4 can be used to issue such communications.

The information technology platform according to the invention is preferably web-based and allows direct access to other resources related to the disease under treatment or the treatment itself. In the preferred embodiments, examples of such websites would be MS-related sites, other registries created in accordance with the methods described herein, Medline, and clinicaltrials.gov.

In addition to providing patient-experience data, the web platform may also provide training- or education-related information in the form of video, flash presentations or documents. The training can be directed to either physicians, other health professionals (like nurses), or patients. In one example the web platform provides pregnancy-related information or education.

In a further embodiment, a patient may be able to record and report outcomes via a secure web interface. The computer system may also be programmed to notify and/or remind patients of required follow-up assessments based on a standard treatment regimen. Similarly, the computer system may notify/remind physician of needed/recommended follow-up for his/her patients undergoing a particular treatment.

As mentioned, the computer system provides for the inclusion of data from clinical trials. Data from multiple clinical trials may be included (both completed and ongoing). It may also track patients moving across trials.

The data may be entered electronically (via a standard web interface using a keyboard), or by completion of paper documents that are then converted to a form usable by the computer (e.g. by scanning, etc.).

In order to have as much useful data as possible for use by physicians, the data in the databases described herein may be based on patients in many different countries. The system allows the user to select a language from a set of choices, with the web-based platform capable of interacting with the user in the selected language. This is convenient to the user, and also reduces the likelihood of confusion or errors in data entry or comprehension of recommendations or other data provided by the computer system.

In order to secure patient and medical data privacy, security protocols are employed. For example, a physician will have full access to the record that he/she has entered, but may only access medical data (absence any patient identification data) for the queries that he/she runs. In another example, nurse may have access whose content is restricted by the prescriber physician. This can be accomplished by comparing the user name to a list of authorized recipients of the data. If the user name matches the user creator, for example, then full access to the record can be obtained. Alternatively, user identification numbers, instead of names, can be compared with a list of authorized user identification numbers. Fields within the patient record can be separately tagged as sharable or private based on applicable laws and regulations. For example, users in different countries may be due different level of privacy protection, and can be assigned different privacy levels by these tags. In a similar manner, patients can be given access to files reflecting data on him or her, but not data on other patients.

1. An information system for storing and providing access to data concerning patients that have received treatment by a drug, comprising:
one or more storage elements containing data concerning patients or healthy volunteers that have received the drug, wherein said data comprises data from clinical trials and data from patients prescribed the drug by a physician;
a processor programmed to search said one or more storage elements for data on patients meeting a specified profile and to create a dataset;
wherein the dataset comprises information on patients having the specified profile, including a response to the patients to treatment using the drug.

2. An information system according to claim 1, wherein the data concerning patients that have received the drug includes data concerning side effects and/or adverse reactions experienced by the patients.

3. An information system according to claim 2, further comprising a communication element for transmitting data to a remote location.

4. An information system according to claim 3, where the communication element comprises a web interface or an email server.

5. An information system according to claim 3, wherein the one or more storage elements further contain data on follow-up care recommended or needed by patients and said information system notifies the health care professionals in charge of a patient being treated with said drug of follow-up care recommended or needed by patients based on said data on follow-up care.

6. An information system according to claim 5, further comprising an input element for receiving user input concerning alerts to be issued to the health care professionals in charge of patients being treated with said drug that relate to said patients, wherein said information system transmits the alerts to said health care professionals.

7. An information system according to claim 6, wherein said alerts apply only to patients meeting a specific profile, said processor searches the data within the storage element to identify patients meeting the specific profile and said communication element transmits the alert to a health care person associated with each of said identified patients.

8. An information system according to claim 7, wherein the care professional is the prescriber physician or the nurse in charge of the treated patient.

9. An information system for determination of the risk of side effects or adverse reactions possibly associated with treating a patient with a drug, said information system comprising:
a. A computer network;
b. A centralized first database containing a risk profile from the possible side effects or adverse reactions of said drug,
c. An input device interconnected with the computer network to allow a user to input test results to a second database, the test results comprising a medical history of the patient; and results of screening examinations to determine baseline measurements for conditions including but not limited to the ones affected by said possible side effects or adverse reactions; and generating a risk profile of the patient;
d. accessing the first database and comparing the test results in the second database to the known risk profile in the first database;
e. determining the measure of identity of the possible risk profile and the patient risk profile; and
f. generating a report of whether the risk of side effects or adverse reactions occurring of treatment with said drug is acceptable.

10. An information system according to claim 9, wherein the side effects or adverse reactions in the first database are side effects and adverse reactions that have been experienced by patients or healthy volunteers that have previously received said drug.

11. An information system according to claim 10, wherein the user is the prescriber physician or the nurse in charge of the treated patient.

12. An information system according to claim 10, further containing data on the disease to be treated.

13. A computerized method of evaluating suitability of treating a patient with a drug, comprising:
entering data concerning said patients, and optionally on required follow up care or monitoring into a computer, said data including a patient profile;
using the computer to compare the patient profile with data stored within the computer concerning the profiles of prior recipients of said drug:
based on said comparison, identifying prior recipients having received the drug that are at least in part the same as the profile of the patient under evaluation for treatment with the drug; providing data concerning the identified prior recipients and one or more experiences of the identified prior recipients with said drug for the purpose of evaluating the suitability of treatment of said patient with said drug.

14. A computerized method of implementing a follow up care and monitoring to be performed before and/or during administering a drug to a patient, comprising:
entering data concerning said patients, into a computer, said data including a patient profile;
entering data concerning the follow up care or monitoring steps to be performed for each patient profile into a computer, said data including description and timing of the follow up care or monitoring steps, and optionally location of adequate heath care professionals who can perform such follow up care or monitoring steps;
using the computer to compare the patient profile with data stored within the computer concerning the profiles of prior recipients of said drug,
based on said comparison, identifying prior recipients having received the drug that are at least in part the same as the profile of the patient under evaluation for treatment with the drug,
based on said identification, identifying the follow up care or monitoring steps to be performed to said patient and timing thereof, e.g. identifying the adequate heath care professionals who can perform such follow up care or monitoring steps.

15. A computerized method of claim 14, wherein the patient profile includes data on treatment dosage and dosing regimen received by the patient.

16. A computerized method of determining conditions of administering a drug to a patient, said method comprising:
entering data concerning said patients into a computer, said data including a patient profile, treatment dosage, dosing regimen
entering data concerning prior recipients of said drug, said data including side effects, adverse events experienced by said prior recipients, and treatment dosage and dosing regimen of said prior recipients
using the computer to compare the patient profile with data stored within the computer concerning the prior recipients of said drug
based on said comparison, identifying prior recipients having received the drug that are at least in part the same as the profile of the patient under evaluation for treatment with the drug; for the purpose of evaluating the appropriate dosing or dosing regimen.

17. The computerized method of claim 13, wherein said provided data includes data concerning outcomes of the treatments administered to said identified prior recipients, side effects experienced by said identified prior recipients, and/or any adverse reactions experienced by said identified prior recipients.

18. The information system of claim 12, or a computerized method of claim 34, wherein the drug is a S1P receptor modulator or agonist.

19. The information system of claim 12, or the computerized method of claim 34, wherein the drug is 2-amino-2-[2-(4-octylphenyl)ethyl]propane-1,3-diol (FTY720) in free form, a pharmaceutically acceptable salt thereof or FTY720-phosphate derivative, e.g. FTY720.

20. A computerized method of administering a S1P receptor modulator or agonist to a person in need thereof, comprising:
collecting patient data and medical data concerning patients who have taken a S1P receptor modulator in a registry stored on a computer, said patient data including age, weight and sex of said patient and said medical data including treatment dosage, dosing regimen, and side effects or adverse reactions occurring in said patient;
providing at least a subset of said patient data and medical data to a physician for use in evaluating a manner for administering said S1P receptor modulator to said person in need thereof.

21. A computerized method of administering a S1P receptor modulator or agonist to a patient, comprising:
entering data concerning said patient into a computer, said data including a patient profile;
using the computer to compare the patient profile with data stored within the computer concerning the profile of prior recipients of S1P receptor modulators:
based on said comparison, identifying prior recipients that have profiles that are at least in part the same as the profile of the patient under consideration for treatment with the S1P receptor modulator;
providing data concerning identified prior recipients and their experiences with S1P receptor modulator or agonist for the purpose of determining the treatment of said patient.

22. The computerized method of claim 20, wherein said provided data is used to evaluate the risk/benefit profile for treatment of said patient, or to evaluate dosing or a dosing regimen or to define the necessary follow up care or monitoring.

23. The computerized method of claim 20, wherein said data concerning prior recipients includes both recipients who participated in a clinical trials for said S1P receptor modulator or agonist and recipients who were prescribed said S1P receptor modulator or agonist by a physician.

24. The computerized method claim 20, wherein the S1P receptor modulator or agonist is 2-amino-2-[2-(4-octylphenyl)ethyl]propane-1,3-diol (FTY720) in free form, a pharmaceutically acceptable salt thereof, FTY720-phosphate derivative, e.g. FTY720.

25. The information system of claim 18, or a computerized method of claim 20, wherein the patient is treated for an autoimmune or inflammatory disease, e.g. multiple sclerosis.

26. The information system of claim 19, or the computerized method of claim 20 wherein the patient is already under treatment with a multiple sclerosis drug, or has not yet being treated for multiple sclerosis.

27. The computerized method of claim 13, further comprising
entering data concerning prior recipients of S1P receptor modulator or agonist
comparing data concerning the patient with said data on prior recipients of S1P receptor modulator or agonist, for the purpose of evaluating the side effects and adverse reactions experienced by the patient which are related to the S1P receptor modulator or agonist.

28. The computerized method of claim 13, further comprising
entering data concerning other patients suffering from multiple sclerosis and/or treated by other multiple sclerosis drug
comparing data concerning the patient with said data on multiple sclerosis patients, for the purpose of evaluating the side effects and adverse reactions experienced by the patient which are related to the disease.

29. The computerized method of claim 17, further comprising remotely providing the patient with information about the necessary follow up care or monitoring steps to be performed.

30. The computerized method of claim 17, further comprising remotely reminding or alerting the patient about the need and adequate timing of performing the necessary follow up care or monitoring steps.

31. The information system of claim 12, further comprising a system to remotely reminding or alerting the patient about the need and adequate timing of performing the necessary follow up care or monitoring steps.

32. The computerized method of claim 14, wherein said provided data includes data concerning outcomes of the treatments administered to said identified prior recipients, side effects experienced by said identified prior recipients, and/or any adverse reactions experienced by said identified prior recipients.

33. The computerized method of claim 15, wherein said provided data includes data concerning outcomes of the treatments administered to said identified prior recipients, side effects experienced by said identified prior recipients, and/or any adverse reactions experienced by said identified prior recipients.

34. The computerized method of claim 16, wherein said provided data includes data concerning outcomes of the treatments administered to said identified prior recipients, side effects experienced by said identified prior recipients, and/or any adverse reactions experienced by said identified prior recipients.

35. The computerized method of claim 21, wherein said provided data is used to evaluate the risk/benefit profile for treatment of said patient, or to evaluate dosing or a dosing regimen or to define the necessary follow up care or monitoring.

36. The computerized method of claim 21, wherein said data concerning prior recipients includes both recipients who participated in a clinical trials for said S1P receptor modulator or agonist and recipients who were prescribed said S1P receptor modulator or agonist by a physician.

37. The computerized method claim 21, wherein the S1P receptor modulator or agonist is 2-amino-2-[2-(4-octylphenyl)ethyl]propane-1,3-diol (FTY720) in free form, a pharmaceutically acceptable salt thereof, FTY720-phosphate derivative, e.g. FTY720.

38. The information system of claim 18, or a computerized method of claim 21, wherein the patient is treated for an autoimmune or inflammatory disease, e.g. multiple sclerosis.

39. The information system of claim 19, or the computerized method of claim 21, wherein the patient is already under treatment with a multiple sclerosis drug, or has not yet being treated for multiple sclerosis.

40. The computerized method claim 21, wherein the S1P receptor modulator or agonist is 2-amino-2-[2-(4-octylphenyl)ethyl]propane-1,3-diol (FTY720) in free form, a pharmaceutically acceptable salt thereof, FTY720-phosphate derivative, e.g. FTY720.

41. The computerized method of claim 21, further comprising
entering data concerning prior recipients of S1P receptor modulator or agonist
comparing data concerning the patient with said data on prior recipients of S1P receptor modulator or agonist, for the purpose of evaluating the side effects and adverse reactions experienced by the patient which are related to the S1P receptor modulator or agonist.
